(19) United States
(12) Patent Application Publication
(10) Pub. No.: US 2017/0158976 A1
(43) Pub. Date: Jun. 8, 2017

(54) COMPOSITIONS AND METHODS FOR REMOVING HEAVY METALS FROM FLUIDS

(71) Applicant: Chevron U.S.A. Inc., San Ramon, CA (US)

(72) Inventors: Dennis John O'Rear, Petaluma, CA (US); Joshua Allen Thompson, Larkspur, CA (US); Cedrick Mahieux, Benicia, CA (US)

(21) Appl. No.: 14/961,969

(22) Filed: Dec. 8, 2015

(51) Int. Cl. C10L 3/10; E21B 43/34; B01D 11/04; C10G 29/12; C10G 29/16

(52) U.S. Cl. CPC C10L 3/101; C10G 29/12; C10G 29/16; B01D 11/0492; E21B 43/34; C10L 2290/542; C10L 2290/141

(57) ABSTRACT

A sulfidic complexing agent is disclosed that includes a suspension or a solution formed by a reaction between a water-soluble metal compound and a water-soluble sulfidic compound. The sulfidic complexing agent has a pH of from about 5 to about 11 and a molar ratio of metal to sulfur of from about 0.1 to about 1,000. The sulfidic complexing agent is useful for removing elemental mercury from a hydrocarbon fluid by contacting the hydrocarbon fluid with the sulfidic complexing agent. The molar ratio of sulfur in the sulfidic complexing agent to mercury in the hydrocarbon fluid is from about 50 to about 2,500. Also disclosed is a method for concurrently transporting and removing a trace amount of volatile mercury in a CO₂-containing natural gas stream extracted from a subterranean formation. The natural gas stream is transported in a pipeline into which the sulfidic complexing agent is injected. Also disclosed is a method for capturing gas phase elemental mercury from a gas stream in the overhead section of a crude oil distillation unit by contacting the gas stream with the sulfidic complexing agent in the overhead section of the distillation unit to form a treated gas stream.

### TECHNICAL FIELD

The invention relates generally to a composition useful for removing elemental mercury from a hydrocarbon fluid, and further to methods using the composition useful for removing elemental mercury from a hydrocarbon fluid.

### BACKGROUND

Heavy metals such as mercury (Hg) can be present in trace amounts in all types of produced fluids such as natural gases and crude oils. The amount can range from below the analytical detection limit to several thousand ppbw (parts per billion by weight) depending on the source. In the case of natural gas and natural gas liquids, it is likely to be present as elemental mercury; whilst in crude oil it may also be present as mercuric sulfide (metacinnabar) and or possibly organo-metallic and ionic mercury.

Methods have been disclosed to remove heavy metals such as mercury from produced fluids. U.S. Patent Publication No. 2011/0253375 discloses an apparatus and related methods for removing mercury from reservoir effluent by placing materials designed to adsorb mercury into the vicinity of a formation at a downhole location, and letting the reservoir effluent flow through the adsorbing material. U.S. Patent Publication No. 2012/0073811 discloses a method for mercury removal by injecting a solid sorbent into a wellbore intersecting a subterranean reservoir containing hydrocarbon products. U.S. Patent Publication No. 2014/0066683 describes removal of elemental mercury by use of inorganic polysulfides injected at the well head. However, inorganic polysulfides are unstable and precipitate as viscous elemental sulfur when the pH drops as a result of processing gases high in CO₂.

Other common approaches utilize treatments for the fluids once the fluids are recovered from subterranean reservoirs and brought to a surface production installation. U.S. Pat. No. 4,551,237 discloses the use of an aqueous solution of sulfide materials to remove arsenic from oil shale. U.S. Pat. No. 4,877,515 discloses a process for removing mercury from hydrocarbon streams, gas or liquid. U.S. Pat. No. 4,915,818 discloses a method of removing mercury from liquid hydrocarbons (natural gas condensate) by contact with a dilute aqueous solution of alkali metal sulfide salt. U.S. Pat. No. 6,268,543 discloses a method for removing elemental mercury with a sulfur compound. U.S. Pat. No. 6,350,372 discloses removing mercury from a hydrocarbon feed by contact with an oil soluble or oil miscible sulfur compound U.S. Pat. No. 4,474,896 discloses using polysulfide based absorbents to remove elemental mercury (Hg⁰) from gaseous and liquid hydrocarbon streams. U.S. Patent Publication No. 2013/0152788 discloses a process for removing mercury from a gas or liquid phase, wherein the gas or liquid phase containing mercury is placed in contact with a composition comprising a precipitated metal sulfide.

There is still a need for improved methods to remove heavy metals, particularly mercury, from hydrocarbon fluids such as natural gas, particularly upstream from a natural gas processing plant.

### SUMMARY

In one aspect, an aqueous metal sulfide colloid complexing agent is provided that includes a suspension or a solution formed by a reaction between a water-soluble metal compound and a water-soluble sulfidic compound. The water-soluble metal compound can include a metal selected from the group consisting of Ti, Zr, Hg, V, Nb, Ta, Cr, Mo, W, Mn, Re, Fe, Ru, Os, Co, Rh, Ir, Ni, Pd, Pt, Cu, Ag, Au, Zn, Cd, Ga, In, Tl, Sn, Pb, As, Sb, Bi, Se, Te and combinations thereof. The water-soluble sulfidic compound can be selected from the group consisting of sodium polysulfide, ammonium polysulfide, calcium polysulfide, sodium hydrosulfide, potassium hydrosulfide, ammonium hydrosulfide, sodium sulfide, potassium sulfide, calcium sulfide, magnesium sulfide, ammonium sulfide, sulfanes, hydrogen sulfide, sodium thiocarbamate, sodium dithiocarbamate, ammonium thiocarbamate and ammonium dithiocarbamate and mixtures thereof. The aqueous metal sulfide colloid complexing agent has a pH of from about 5 to about 11 and a molar ratio of metal to sulfur of from about 0.1 to about 1,000.

In another aspect, a method is provided for removing elemental mercury from a hydrocarbon fluid including contacting the hydrocarbon fluid using the aqueous metal sulfide colloid complexing agent in an aqueous phase. The molar ratio of sulfur in the aqueous metal sulfide colloid complexing agent to mercury in the hydrocarbon fluid is from about 50 to about 2,500. At least about 90% of the mercury in the hydrocarbon fluid is removed from the hydrocarbon liquid and into the aqueous phase.

In another aspect, the invention relates to a method for concurrently transporting and removing a trace amount of volatile mercury in a CO₂-containing natural gas stream extracted from a subterranean formation. The method includes obtaining a produced fluid containing natural gas and produced water from the subterranean formation, the produced fluids having an initial concentration of volatile mercury. The produced fluid is transported in a pipeline into which a sulfidic complexing agent in an aqueous phase is injected. Volatile mercury in the produced fluid transported in the pipeline reacts with the sulfidic complexing agent to form at least one non-volatile mercury-containing complex. The treated produced fluid has a final concentration of volatile mercury lower than the initial concentration of volatile mercury.

In another aspect, the invention relates to a method for capturing gas phase elemental mercury from a gas stream in the overhead section of a crude oil distillation unit. The gas stream is contacted with a sulfidic complexing agent in the overhead section of the crude oil distillation unit to form a treated gas stream having a final concentration of gas phase elemental mercury lower than the initial concentration of gas phase elemental mercury in the gas stream.

### BRIEF DESCRIPTION OF THE DRAWINGS

These and other objects, features and advantages of the present invention will become better understood with reference to the following description, appended claims and accompanying drawings where:

FIG. 1 is a diagram illustrating a system for the removal of mercury from a pipeline as natural gas is transported from a subsea well to a processing facility according to one embodiment.

FIG. 2 is a diagram illustrating a system for the recovery/regeneration of hydrate inhibitor(s) and sulfidic complexing agent(s) at the production facility, after the pipeline reaction for the removal of mercury according to one embodiment.

FIG. 3 is a diagram illustrating a system for the recovery of mercury in the overhead section of a crude oil distillation unit according to one embodiment.

### DEFINITIONS

The following terms will be used throughout the specification and will have the following meanings unless otherwise indicated.

“Sulfidic Complexing Agent” refers to a chemical composition which is dissolved or dispersed in an aqueous phase and which is capable of binding elemental mercury and removing it from a hydrocarbon fluid. Sulfidic complexing agents can be either an aqueous metal sulfide colloid complexing agent, or a pH-controlled monosulfide complexing agent. The pH-controlled monosulfide complexing agent is an aqueous solution of a monosulfide such as sodium sulfide, sodium hydrosulfide and corresponding potassium and ammonium compounds, where the pH is controlled to between 7 and 9 under the conditions of adsorption. If during use, the pH of a pH-controlled monosulfide complexing agent would be below 7, the pH can be raised by addition of an acid neutralizer. If during use, the pH of a pH-controlled monosulfide complexing agent would be above 9, the pH can be lowered by addition of an appropriate acid, such as hydrochloric acid, acetic acid, carbonic acid and the like.

“Pipeline” may be used interchangeably with “production line,” referring to a riser and any other pipeline used to transport production fluids to a production facility. The pipeline may include, for example, a subsea production line and a flexible jumper.

“Production facility” means any facility for receiving natural gas and preparing the gas for sale. The production facility may be a ship-shaped vessel located over a subsea well site, an FPSO vessel (floating production, storage and offloading vessel) located over or near a subsea well site, a near-shore separation facility, or an onshore separation facility. Synonymous terms include “host production facility” or “gathering facility.”

“Subsea production system” means an assembly of production equipment placed in a marine body. The marine body may be an ocean environment or a fresh water lake. Similarly, “subsea” includes both an ocean body and a deepwater lake.

“CO₂-containing natural gas” refers to natural gas containing CO₂. CO₂-containing natural gas will form acidic solutions when the water in the gas condenses. This acidic water can deactivate complexing agents by causing them to precipitate as elemental sulfur, or lose activity in general. In one embodiment, CO₂-containing natural gas streams contain 1 mol percent or more CO₂ in the gas separated from water and hydrocarbon condensates at atmospheric pressure and 20° C. In another embodiment the CO₂-containing natural gas streams contain 5 mol percent or more CO₂. In another embodiment the CO₂-containing natural gas streams contain 10 mol percent or more CO₂. CO₂-containing natural gas streams can also include other acids such as acetic, propanoic, or butanoic acid which further drop the pH of the aqueous stream and can deactivate complexing agents. Upon condensation with the water, the acids are carbonic, acetic and combinations. These are typically present in individual ranges of greater than or equal to 10 ppm to less than or equal to 1 wt % in the water. In the presence of these acids, the pH would typically drop to near 4. This is highly corrosive and to counter this, basic compounds such as caustic, sodium carbonate, or amines are typically added to control the pH from greater than or equal to 6 to less than or equal to 8. A typical amine is methyldiethanol amine. Mercury removal is carried out in the presence of the acids, the amines, and at these pH ranges.

“Heavy metals” refers to gold, silver, mercury, osmium, ruthenium, uranium, cadmium, tin, lead, selenium, and arsenic. While the description described herein refers to mercury removal, in one embodiment, the treatment removes one or more of the heavy metals.

“Hydrates” or “hydrate particles” refers to crystals formed by water in contact with natural gases and associated liquids, as an ice-like substance, typically in a ratio of 85 mole % water to 15% hydrocarbons. Hydrates can form when hydrocarbons and water are present at the right temperature and pressure, such as in wells, flow lines, or valves. The hydrocarbons become encaged in ice-like solids which rapidly grow and agglomerate to sizes which can block flow lines. Hydrate formation most typically occurs in subsea production lines, which are at relatively low temperatures and elevated pressures. Hydrates also include solids formed by reaction of carbon dioxide and water.

“Hydrocarbon fluid” refers to either a gas or liquid containing 75 wt % or more hydrocarbons, where hydrocarbons have the traditional definition of being composed of exclusively carbon and hydrogen. Examples of hydrocarbon fluids are natural gas (either gas or liquid), propane (either gas or liquid), butane (either gas or liquid), petroleum crude (liquid), and petroleum condensate (liquid).

“Mercury sulfide” may be used interchangeably with HgS, referring to mercurous sulfide, mercuric sulfide, and mixtures thereof. Normally, mercury sulfide is present as mercuric sulfide with an approximate stoichiometric equivalent of one mole of sulfide ion per mole of mercury ion. Mercury sulfide is not appreciably volatile, and not an example of volatile mercury. Crystalline phases include cinnabar, metacinnabar and hypercinnabar with metacinnabar being the most common.

“Produced fluids” refers the mixture of hydrocarbons, e.g., natural gas, some crude oil, hydrocarbon condensate, and produced water that is removed from a geologic formation via a production well.

“Produced water” refers to the water generated in the production of oil and/or natural gas, including formation water, i.e., water present naturally in a reservoir, or water that leaves the well as a liquid, condensed water, i.e., water that leaves the well as a gas and subsequently condenses in the production line, as well as water previously injected into a formation either by matrix or fracture injection, which can be any of connate water, aquifer water, seawater, desalinated water, industrial by-product water, and combinations thereof.

“Trace amount” refers to the amount of mercury in the natural gas. The amount varies depending on the natural gas source, ranging from 0.01 μg/Nm³ to up to 30,000 μg/Nm³.

“Volatile mercury” refers to mercury that is present in the gas phase of well gas or natural gas. In one embodiment, volatile mercury comprises primarily elemental mercury) (Hg⁰) with some dialkylmercury compounds (dimethyl mercury).

### DETAILED DESCRIPTION

Generally, natural gas streams comprise low molecular weight hydrocarbons such as methane, ethane, propane, other paraffinic hydrocarbons that are typically gases at room temperature, etc. Mercury can be present in natural gas as volatile mercury, including elemental mercury Hg⁰, in levels ranging from about 0.01 μg/Nm³ to 30,000 μg/Nm³. The mercury content may be measured by various conventional analytical techniques known in the art, including but not limited to cold vapor atomic absorption spectroscopy (CV-AAS), inductively coupled plasma atomic emission spectroscopy (ICP-AES), X-ray fluorescence, or neutron activation. If the methods differ, ASTM D 6350 is used to measure the mercury content.

Depending on the source of the natural gas, in addition to mercury, natural gas streams can contain water, referred to as produced water, in varying amounts ranging from 0.1 to 90 vol. % water in one embodiment, from 5 to 70 vol. % water in a second embodiment, and from 10 to 50 vol. % water in a third embodiment. The volume percentages are calculated at the temperature and pressure of a pipeline carrying the natural gas stream.

Natural gas is often found in wells located in remote locations and must be transported from the wells to developed locations for use. This can be done by a production line, or by conversion of the methane in the natural gas into Liquefied Natural Gas (LNG) for transport. Natural gas pipelines can become clogged with gas hydrates. The hydrates can be methane-water hydrates, carbon dioxide-water hydrates, or other solid hydrates. Hydrates can also be found in gas exploration at ocean depths. At a depth such as, for example, 500 m, the pressure can be about 50 atmospheres and the temperature can be from 4 to 5° C. These conditions are ideal for gas hydrate formation. Gas hydrates also may form in permafrost regions near the surface in regions such as Alaska, in sedimentary formations where hydrocarbons, water, and low temperatures are found.

In offshore production, the conditions conducive to hydrate formation commonly occur during transient operations, e.g. at shutdown and restart conditions, due to low temperatures, but can also occur under steady-state production conditions, such as those typical of long subsea tiebacks. Hydrate formation can restrict flow and even form a solid plug to block all production in a short time period. Hydrate inhibitors have been used to solve the hydrate formation problem by depressing both the hydrate and freezing temperatures.

In one embodiment, a method is disclosed for removing heavy metals such as mercury present in CO₂-containing containing natural gas streams. The natural gas stream is contacted with a sulfidic complexing agent in an aqueous phase. The sulfidic complexing agent is capable of converting volatile mercury in the natural gas into a form which is not volatile, referred to as a non-volatile mercury complex. The non-volatile mercury complex remains in the aqueous phase.

The sulfidic complexing agent can be an aqueous metal sulfide colloid complexing agent. Examples of aqueous metal sulfide colloid complexing agents for the removal of gas phase elemental mercury include but are not limited to the reaction product of a water-soluble sulfidic compound and a water-soluble metal compound where the metal is selected from Ti, Zr, Hg, V, Nb, Ta, Cr, Mo, W, Mn, Re, Fe, Ru, Os, Co, Rh, Ir, Ni, Pd, Pt, Cu, Ag, Au, Zn, Cd, Ga, In, Tl, Sn, Pb, As, Sb, Bi, Se, Te and combinations. The reaction product is either a solution, or a suspension of very fine particles of which less than 50% settle in 1 hour after mixing in one embodiment. In another embodiment, less than 10% settle in one hour. In another embodiment, the reaction product is a solution from which no particles settle. The metal can be in a cationic or anionic form. Examples of cationic forms are CuCl₂, CuCl, FeCl₃, and SeCl₄. Examples of anionic form are Na₂MoO₄ and KMnO₄.

Examples of the water-soluble sulfidic compound include sodium polysulfide, ammonium polysulfide, calcium polysulfide, sodium hydrosulfide, potassium hydrosulfide, ammonium hydrosulfide, sodium sulfide, potassium sulfide, calcium sulfide, magnesium sulfide, ammonium sulfide, sulfanes, hydrogen sulfide, sodium thiocarbamate, sodium dithiocarbamate, ammonium thiocarbamate and ammonium dithiocarbamate and mixtures. Sulfanes have the formula of H₂S₂, H₂S₃, H₂S₄, higher homologs and mixtures). Examples of water-soluble monatomic sulfur compounds include sulfides (such as sodium, potassium and ammonium sulfide), hydrosulfides (such as sodium, potassium or ammonium hydrosulfide), and hydrogen sulfide.

In one embodiment, the molar ratio of the sulfur in water-soluble sulfidic compound to the water-soluble metal compound should be greater than or equal to 0.1 and less than or equal to 1,000. In another embodiment, the molar ratio of the sulfur in water-soluble sulfidic compound to the water-soluble metal compound should be greater than or equal to 0.25 and less than or equal to 100. In another embodiment, the molar ratio of the sulfur in water-soluble sulfidic compound to the water-soluble metal compound should be greater than or equal to 0.5 and less than or equal to 10.

The sulfidic complexing agent can be a pH-controlled monosulfide complexing agent. The pH-controlled monosulfide complexing agent is an aqueous solution of a monosulfide such as sodium sulfide, sodium hydrosulfide and corresponding potassium and ammonium compounds, where the pH is controlled to between 7 and 9 under the conditions of adsorption. If during use, the pH of the pH-controlled monosulfide complexing agent falls below 7, the pH can be raised by adding an acid neutralizer. If during use, the pH of the pH-controlled monosulfide complexing agent exceeds 9, the pH can be lowered by adding an appropriate acid, such as hydrochloric acid, acetic acid, carbonic acid and the like.

Examples of non-volatile mercury complexes formed in the methods of the present disclosure include mercuric sulfide (e.g., HgS). These complexes are part of the sulfidic complexing agent (typically on the surface) and together they can be removed from liquid phases by ion exchange, distillation or drying of the water, and precipitation coupled with centrifugation or filtration. Once removed, the non-volatile mercury complexes can be further concentrated by thermal decomposition to form a concentrated gas stream of elemental mercury, extraction with caustic sulfidic solutions and combinations.

In one embodiment, the present disclosure relates to methods for concurrently transporting natural gas by pipeline and removing heavy metals such as mercury contained in the natural gas, wherein the mercury removal occurs in the course of transferring natural gas through the pipeline. The addition of the sulfidic complexing agent can be continuous or intermittent. The sulfidic complexing agent can be added to a pipeline at the well head, into a manifold, intermediate locations between the production well and a processing facility, into at least a location downhole in the wellbore, or combinations of the above. In one embodiment, the sulfidic complexing agent is introduced, also referred to herein as injected, into the pipeline at an entry point at the wellhead or close to the well head, e.g., within 1000 ft, within 500 ft, or within 100 ft of the well head. In yet another embodiment, the sulfidic complexing agent is introduced at intervals in the pipeline carrying the natural gas from the well head to a processing facility, for the reaction to remove the mercury to take place in the pipeline before the natural gas reaches its destination.

The amount of sulfidic complexing agents to be added to the pipeline for mercury removal is determined by the effectiveness of sulfidic complexing agent employed. The amount of sulfur in the sulfidic complexing agent is at least equal to the amount of mercury in the natural gas on a molar basis (1:1), if not in an excess amount. In one embodiment, the molar ratio, i.e., mol sulfur in the sulfidic complexing agent to mol mercury, ranges from 2 to 100,000. In another embodiment, the molar ratio ranges from 10 to 25,000. In yet another embodiment, the molar ratio ranges from 50 to 2500.

The amount of sulfidic complexing agent added is limited to 5 wt. % or less of the water phase in the pipeline in one embodiment, and less than 2 vol. % in a second embodiment.

With the addition of sulfidic complexing agent to the pipeline, volatile mercury is extracted from the gas phase onto the sulfidic complexing agent, for a treated gas stream having a mercury concentration of less than 50% of the original mercury concentration in the natural gas. In another embodiment, the treated gas contains less than 25% of the original mercury level (i.e., at least 75% removal). In a third embodiment, the treated gas contains less than 10% of the original mercury level (i.e., at least 90% removal). The mercury content in the treated gas stream will depend on the mercury content of the feed and the sulfidic complexing agent employed. The analytical method can be any of a number of suitable cold vapor atomic absorption spectroscopy (CVAAS) methods, such as Lumex, Sir Galahad, etc. The reduction in mercury concentration can be observed by measuring the gas initially and then after injection of the sulfidic complexing agent. Alternatively, a sample at the well head can be obtained and compared with the sample at the exit of the pipeline.

In one embodiment, the pipeline is of sufficient length that, in the course of transporting the natural gas there through, sufficient mixing of produced fluid and sulfidic complexing agent occurs for reactions to take place between the sulfidic complexing agent and the heavy metals. In this pipeline reaction, mercury forms aqueous complexes, and is extracted by the sulfidic complexing agent. In one embodiment wherein mercury reacts with the sulfidic complexing agent to form insoluble complexes on the sulfidic complexing agent, the mercury complexes on the sulfidic complexing agent can then be removed by filtration, settling, or other methods known in the art, e.g., removal of solids from a gas or liquid stream to produce a hydrocarbon product with reduced mercury content.

The pipeline is sufficiently long for a residence time of at least one second in one embodiment, at least 10 minutes in another embodiment, at least 30 minutes in yet another embodiment, at least 10 hours in a fourth embodiment. The residence time can be in the range of 20-200 hours if the pipeline extends for hundreds if not thousands of kilometers. In one embodiment, the reaction takes place over a relatively short pipeline, e.g., from about 10 m to about 50 m, e.g., for intra-facility transport. In yet another embodiment, the reaction takes place in a pipeline section over a long distance transport of at least 2.5 km. In one embodiment the flow in the pipeline is turbulent, and in another embodiment the flow is laminar.

For effective removal of mercury from the produced fluids with sufficient mixing to create a dispersion of the sulfidic complexing agent, the pipeline has a minimum superficial liquid velocity of at least 0.1 m/s in one embodiment; at least 0.5 m/s in a second embodiment; and at least 5 m/s in a third embodiment. In one embodiment, the natural mixing in the pipeline can be augmented with the use of mixers at the point of introduction of the sulfidic complexing agent, or at intervals downstream in the pipeline. Examples include static or in-line mixers as described in Kirk-Othmer Encyclopedia of Chemical Technology, Mixing and Blending by David S. Dickey, Section 10, incorporated herein by reference. In order to prevent settling in the pipelines, the sulfidic complexing agent should include particle sizes as small as practically possible. The sulfidic complexing agent is preferably a stable suspension or a clear solution.

The mercury removal in the pipeline can be land-based, located subsea, or can be a combination thereof, by extending from a production site to a crude processing facility, receiving production flow from a surface wellhead or other sources. Examples of the pipeline include subsea pipelines, where the great depth of the pipeline can make the pipeline relatively inaccessible, and where the pipelines include a header or vertical section that forms a substantial pressure head. The pipeline system can be on-shore, off-shore (as a platform, FPSO, etc), or a combination thereof. For off-shore locations, the pipeline system can be a structure rising above the surface of the water, e.g., a well platform, or it can be sub-surface, e.g., on the seabed.

In one embodiment, where the production site is at a sufficient distance from the processing facility, the pipeline system includes intermediate collection and/or processing facilities. The intermediate facilities contain one or more supply tanks to dispense sulfidic complexing agents and/or other optional process aids, e.g., hydrate inhibitors, foamants, NaOH, diluents, etc., to facilitate the flow of produced fluids in into the pipeline. In another embodiment, the intermediate facilities may also include equipment such as gravity separator, plate separator, hydroclone, coalescer, centrifuge, filter, collection tanks, etc., for the separation, storage, and treatment of recovered stream containing optional hydrate inhibitor(s) and sulfidic complexing agents).

In addition to the sulfidic complexing agent, optional additives may also be injected into the pipeline in the aqueous phase. Such optional additives can include anti-foam material, oxygen scavenger, scale inhibitor, acid neutralizer and/or demulsifier.

In one embodiment, anti-foam material is added as an optional additive. As used herein, the term anti-foam includes both anti-foam and defoamer materials, for preventing foam from happening and/or reducing the extent of foaming. Additionally, some anti-foam materials may have both functions, e.g., reducing or mitigating foaming under certain conditions, and preventing foam from happening under other operating conditions. Anti-foam materials can be selected from a wide range of commercially available products such as silicones, e.g., polydimethyl siloxane (PDMS), polydiphenyl siloxane, fluorinated siloxane, etc., in an amount of 1 to 500 ppm.

In one embodiment, at least an oxygen scavenger is present as an optional additive in an amount ranging greater than or equal to 0.001 to less than or equal to 1 wt. %. Oxygen scavengers reduce the dissolved oxygen content of the fluid in the pipeline to low levels so that corrosion in stainless steel sections of the pipeline is minimized. In one embodiment, they are added in an amount to control the oxygen content to less than or equal to 100 ppb. In another embodiment, they are added in an amount to control the oxygen content to less than or equal to 10 ppb. Examples of oxygen scavengers include metabisulfites, hydrazine salts, hydroxylamine salts, guanidine salts, dithionites, diethylhydroxylamine, acetaldehyde oxime, D-(−)-isoascorbic acid and combinations.

In one embodiment, at least a scale inhibitor is used as an optional additive to control the deposition of inorganic salts on the surface of the pipe. These salts can be carbonates, sulfides, sulfates, and conventional sodium chloride. Scale inhibitor(s) can be present in an amount ranging greater than or equal to 0.001 to less than or equal to 1 wt. %. Examples of scale inhibitors are polyphosphates, phosphate esters, aminophosphonates, polyphosponates, polycarboylates, phosphine polymers and polyphosphinates and polysulfonates.

Acid neutralizers are added to counteract the low pH created by acids such as carbonic and acetic acid. Examples of acid neutralizers are sodium hydroxide, ammonium hydroxide, sodium carbonate, sodium bicarbonate, and amines. Examples of amines include methyldiethanol amine. In one embodiment, at least one acid neutralizer is added as an optional additive in amount ranging from greater than or equal to 0.01 and less than or equal to 10 wt %. They control the pH to a range that is not corrosive to carbon steel, such as greater than or equal to 6 and less than or equal to 8.

In one embodiment, at least a demulsifier is added as an optional additive to pipeline in a concentration from 1 to 5,000 ppm. In another embodiment, a demulsifier is added at a concentration from 10 to 500 ppm. In one embodiment, the demulsifier is a commercially available demulsifier selected from polyamines, polyamidoamines, polyimines, condensates of o-toluidine and formaldehyde, quaternary ammonium compounds and ionic surfactants. In another embodiment, the demulsifier is selected from the group of polyoxyethylene alkyl phenols, their sulphonates and sodium sulphonates thereof. In another embodiment, the demulsifier is a polynuclear, aromatic sulfonic acid additive.

In one embodiment, mercury removal is carried out concurrently with a process to manage hydrate formation, e.g., with the injection of a hydrate inhibitor into the pipeline. The hydrate inhibitor is injected along with the sulfidic complexing agent to prevent plugging of the pipeline by hydrates. The hydrate inhibitor to be added to the pipeline along with the sulfidic complexing agent can be any hydrate inhibitor commonly known in the art, e.g., a thermodynamic inhibitor (TI) or a low dosage hydrate inhibitor (LDHI) also referred to as a “threshold inhibitor.” In one embodiment, a sufficient amount of hydrate inhibitor(s), i.e., TI(s) and/or LDHI(s), is added to the production along with the sulfidic complexing agent to shift the hydrate formation equilibrium, decrease the rate of hydrate formation, or prevent agglomeration of hydrates, for a concentration of hydrate particles of <60 vol. %. In another embodiment, a sufficient amount is added for a concentration of hydrate particles of <50 vol. %.

The thermodynamic inhibitor (TI) can be introduced in concentrations of 5-80 vol. % of the water in the produced fluid containing natural gas in one embodiment, and in an amount ranging from 30-60 vol. % in a second embodiment. Suitable compositions for use as the TI are compounds and mixtures of compounds capable of reducing the hydrate formation temperature, e.g., by 0.5 to about 30° C. Examples of suitable TIs include but are not limited to potassium formate, monoethylene glycol (MEG), a diethylene glycol, a triethylene glycol, a tetraethylene glycol, a propylene glycol, a dipropylene glycol, a tripropylene glycol, a tetrapropylene glycol, a polyethylene oxide, a polypropylene oxide, a copolymer of ethylene oxide and propylene oxide, a polyethylene glycol ether, a polypropylene glycol ether, a polyethylene oxide glycol ether, a polypropylene oxide glycol ether, a polyethylene oxide/polypropylene oxide glycol ether, a monosaccharide, a methylglucoside, a methylglucamine, a disaccharide, fructose, glucose, an amino acid, an amino sulfonate, methanol, ethanol, propanol, isopropanol, and combinations thereof. Further details regarding inhibitors are described in U.S. Pat. Nos. 6,080,704, 6,165,945, 6,080,704, 6,225,263, 5,076,364, 5,076,373, 5,083,622, 5,085,282, 5,248,665 the relevant disclosures with respect to the compositions and methods of using thereof are included herein by reference. When the gas arrives at its destination, a portion of the TI can be recovered as a liquid phase and returned to the well site.

The low dosage hydrate inhibitor (LDHI) can be employed in an amount of 0.5-5.0 vol. % of the water present in the produced fluid containing the natural gas. Suitable LDHI compositions include compounds and mixtures capable of any of: decreasing the rate of hydrate formation; keeping the hydrate from forming for a period of time; and allowing for hydrates to form, but preventing them from adhering to each other by keeping the hydrate crystals in a slurry. Examples of suitable LDHIs include but are not limited to oxazolidinium compounds, tertiary amine salts, reaction products of non-halide-containing organic acids and organic amines, polymers having n-vinyl amide and hydroxyl moieties, dendrimeric or branched compounds, linear polymers and copolymers, grafted or branched linear polymers and copolymers, onium compounds, and combinations thereof. Further details regarding LDHI are described in U.S. Pat. Nos. 7,615,102, 6,107,531, 6,180,699; US Patent Publication No. 20120172604, 20120190893, 20120161070, 20120078021, 20120077717, the relevant disclosures with respect to the compositions and methods of using thereof are included herein by reference.

In one embodiment, a hydrate inhibitor mixture of one or more TI and one or more LDHI is used for a synergistic effect. When the gas arrives at its destination, the mixture of the TI and LDHI can be recovered and recycled. Further details regarding a synergistic mixture of TI and LDHI are described in U.S. Pat. No. 7,994,374, the relevant disclosures with respect to the compositions and methods of using thereof are included herein by reference.

In one embodiment, at the pipeline destination, the treated produced fluid is separated under conditions sufficient to provide a gas phase stream, an oil phase stream (if any), and an aqueous phase stream that contains a substantial portion of the water, optional hydrate inhibitor(s), and non-volatile mercury complexes having formed in the pipeline. In one embodiment, up to 99% by volume of the water, optional hydrate inhibitors, unreacted sulfidic complexing agent, and non-volatile mercury complexes are removed from the treated produced fluid stream compounds and isolated in the aqueous phase. A small portion, i.e., less than 1 vol. %, of the water, optional hydrate inhibitors, unreacted sulfidic complexing agent and non-volatile mercury can be entrained in the gas phase and/or the oil phase stream.

The gas phase stream having the reduced concentration of mercury, e.g., less than 50 μg/Nm³ in one embodiment, less than 10 μg/Nm³ in a second embodiment, and less than 1 μg/Nm³ in a third embodiment, can be processed as needed for use or sale. The processing in one embodiment includes further treatment to remove acid gas, e.g., removal of sulfur containing compounds and/or carbon dioxide. In another embodiment, the processing includes dehydration by methods known in the art to produce a gas with a water content suitable for sale or use. In yet another embodiment, the processing includes both acid gas removal and dehydration. In yet another embodiment, the processing includes further mercury removal by contact with a solid adsorbent.

The aqueous phase containing water, optional hydrate inhibitor(s), unreacted sulfidic complexing agent(s), and non-volatile mercury complexes is further treated to separate and remove water, and for the mixture of optional hydrate inhibitor, unreacted sulfidic complexing agent and non-volatile mercury compounds to be re-injected back into the pipeline. Details regarding a process that can be employed for the recovery of the optional hydrate inhibitors can be found in U.S. Pat. No. 7,994,374, the relevant disclosures of which are incorporated herein by reference.

In one embodiment, the aqueous phase stream is flashed in a column or tower at a temperature above the boiling point of water to drive water from the mixture, e.g., at a temperature above 100° C., a temperature above 120° C., at 150° C. or more. The operating pressure of the column can range from a low of about 0.5 bar to a high of about 200 bar. The overhead stream from the column can include up to 0.1 wt. % of hydrate inhibitors, up to 0.01 wt. % of the unreacted sulfidic complexing agents, and less than 0.1 μg/Nm³ mercury. The bottom stream from the column can include from 20 wt. % to 99 wt. % of inhibitors for a recovery of at least 99% by volume of hydrate inhibitors originally added to the pipeline. The bottom stream further comprises from 0 to 30 wt. % water, less than 0.1 wt. % of hydrate-forming compounds, up to 99 wt. % of the unreacted sulfidic complexing agent, and from 50 to 99.9% of the mercury originally present in the untreated produced fluid in the form of non-volatile mercury complexes.

The bottom stream can be recovered and stored in a tank for later use. Additional fresh sulfidic complexing agents, optional hydrate inhibitor, and other additives can be added to the tank in subsequent injection into the pipeline to prevent hydrate formation, concurrently with the removal of mercury from the extracted natural gas. Mercury in the form of non-volatile mercury complexes will gradually build up over time in the recycled hydrate inhibitor stream. This mercury can be removed by processes known in the art, including but are not limited to filtration, centrifugation, precipitation, reduction to elemental mercury followed stripping, distillation, adsorption, ion exchange, or transfer to a hydrocarbon steam and separation, and combinations. The non-volatile mercury complexes can also be removed from precipitated aqueous metal sulfide colloid complexing agent by extraction with aqueous sulfidic solutions as described in U.S. Pat. No. 9,023,196. The extracted aqueous sulfidic complexing agent is a regenerated agent and can then be reused. Distillation at sub-atmospheric pressures and temperatures less than 200° C. can be used to recover the optional hydrate inhibitor as a relatively pure overhead stream. The bottoms from this sub-atmospheric distillation are in the form of a slurry containing additives, sediments, salts, and mercury complexes. Alternatively a portion of the mercury-containing optional hydrate inhibitor stream can be purged from the system. In one embodiment, the non-volatile mercury complexes can be removed from the regenerated/recycled optional hydrate inhibitor stream with the use of a mercury absorber containing a bed of sulfided absorbent as disclosed in U.S. Pat. No. 7,435,338, the relevant disclosure is incorporated herein by reference.

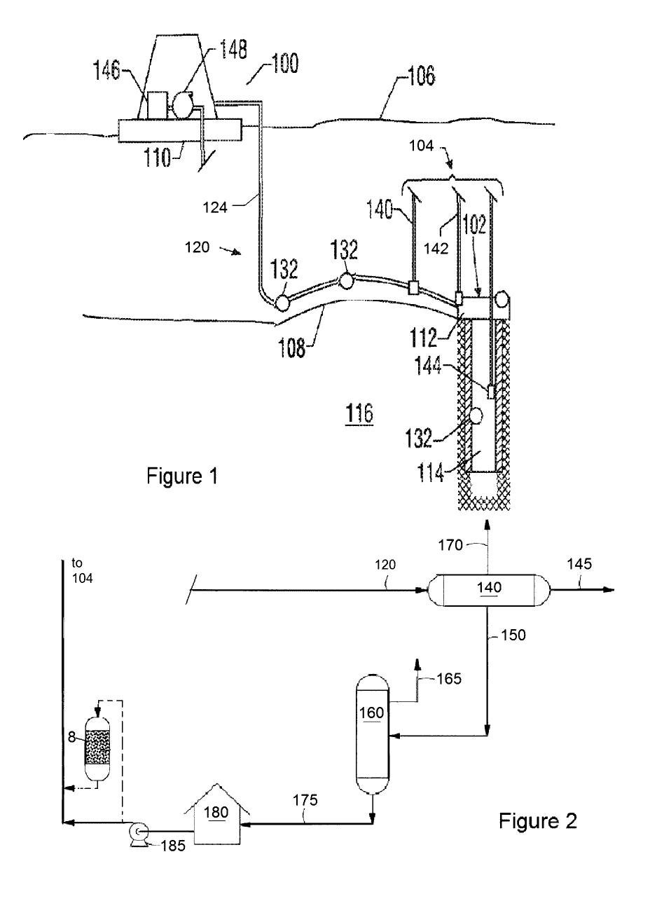

FIG. 1 illustrates a system 104 for the removal of mercury from natural gas as the gas is transported from one or more subsea wells to a surface collection facility 100 such as a floating production, storage and offloading (FPSO) unit, an intermediate collection system, or a processing facility. As shown, the system 104 is for dispensing at least a sulfidic complexing agent into the pipeline deployed in conjunction with the facility 100 located at a water surface 106. The dispensing system 104 services one or more subsea production wells 102 residing in a seabed 108. Each well 102 includes a wellhead 112 and related equipment positioned over a wellbore 114 formed in a subterranean formation 116. Production fluid is conveyed to a surface collection facility such as the FPSO 100 or separate structure, such as an intermediate collection and/or processing facility (not shown), via a pipeline 120. The fluid may be conveyed to the surface facility 100 in an untreated state or after being processed, at least partially, by an intermediate collection and/or processing facility (not shown). The line 120 extends directly from the wellhead 112 or from a manifold (not shown) that receives flow from a plurality of wellheads 112.

The line 120 includes a vertical section or riser 124 that terminates at the FPSO (or a processing facility) 100. The dispensing system 104 continuously or intermittently injects at least a hydrate inhibitor and/or a sulfidic complexing agent into the flow line 120 or the well 102 for the removal of heavy metals.

In one embodiment, the dispensing system 104 can be utilized with one or more sensors 132 positioned along selected locations along the flow line 120 and the well 102. During production operations, the dispensing system 104 can supply or pump one or more hydrate inhibitors and/or sulfidic complexing agents to the flow line 120. The supply of hydrate inhibitors and/or sulfidic complexing agents may be continuous, intermittent or actively controlled in response to sensor measurements. In one mode of controlled operation, the dispensing system 104 receives signals from the sensors 132 regarding a parameter of interest relating to a characteristic of the produced fluid, e.g., temperature, pressure, flow rate, amount of water, concentration of heavy metals in the produced fluids based on the formation of intermediate complexes, etc. Based on the data provided by the sensors 132, the dispensing system 104 determines the appropriate type and/or amount of hydrate inhibitor and/or sulfidic complexing agents needed for the pipeline reactions to take place to reduce the formation of hydrate, the concentration of mercury, arsenic, and the like.

In some embodiments, the dispensing system 104 can include one or more supply lines 140, 142, 144 that dispense hydrate inhibitors, sulfidic complexing agents, other additives, etc. into the pipeline 120 separately or as a single feed line at a location close to the wellhead, or right at the wellhead 102, in a manifold (not shown) or into a location downhole in the wellbore 114, respectively. The supply tank or tanks 146 and injection units 148 can be positioned on the surface facility 110 for continuous supply to the dispensing system 104. In other embodiments, one or more of the lines 140, 142, 144 can be inside or along the pipeline 120, for dispensing of hydrate inhibitors and/or other agents into the pipeline 120.

While multiple dispensation points are shown in FIG. 1, it should be understood that a single dispensation point may be adequate. Moreover, the above-discussed locations are merely representative of the locations at which the hydrate inhibitors and aqueous metal sulfide colloid complexing agents can be dispensed into the production fluid for the pipeline reactions to prevent the formation of hydrate while concurrently remove mercury. The pipeline 120 can extend on land between a production well at a remote location to a facility 100 located in a refinery or a shipping terminal.

In one embodiment as shown in FIG. 2, as the pipeline 120 arrives at the facility 100, the treated produced fluid in the pipe line 120 can be separated in a horizontal pressure separator 140 to provide a treated gas phase 170, an oil phase stream 145, and an aqueous stream 150. The gas phase stream 170 and the oil phase stream 145 can be processed as needed for use or sale.

The aqueous stream 150 can be separated in flash column 160 to remove the captured water from the mixture of hydrate inhibitor(s), unreacted sulfidic complexing agents, and mercury removed from the produced fluid in the form of non-volatile mercury compounds. The overhead stream 165 consists primarily of flashed water and can be disposed, recycled, or injected back into an oil or gas reservoir (in production or depleted). The bottom stream 175 containing recycled/regenerated hydrate inhibitors, unreacted/regenerated sulfidic complexing agents, and mercury compounds can be passed to a storage container 180, which can be sent to the dispensing system 104 for subsequently feeding one or more subsea production wells 102.

In one embodiment as shown in dotted lines, mercury compounds in the recycled/regenerated hydrate inhibitor stream 185 are optionally removed by contacting the stream with a bed 8 of solid absorbent particles, e.g., comprising a sulphided metal and optionally supported on support metal, or sulphur supported on carbon, or ion exchange resin for the removal of the non-volatile mercury compounds before recycling back to dispensing system 104. This needs to be replaced with e.g., a filter or centrifuge.

Sulfidic complexing agents can be used to remove elemental mercury from gas streams other than within pipeline systems. However, since sulfidic solutions slowly oxidize, they are not suitable for removal of mercury from flue gas and air. The oxygen content of the gas stream should be less than or equal to 1 mol. % in one embodiment. In another embodiment, the oxygen content is less than or equal to 0.1 mol. %.

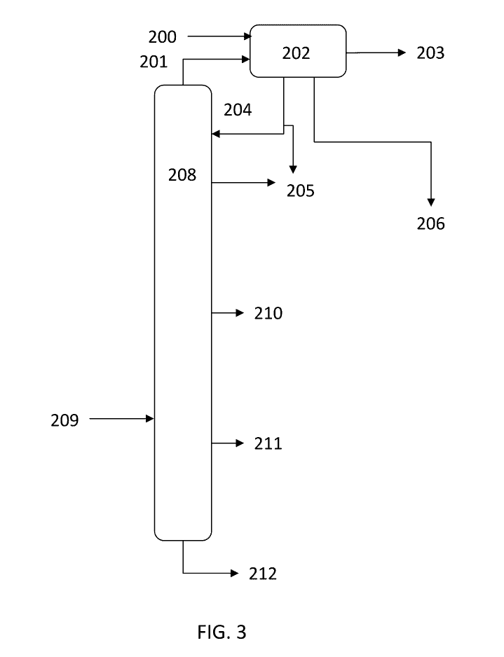

FIG. 3 illustrates a crude distillation unit 208 in a refinery. A crude oil feed stream 209 is fed to the crude distillation unit 208. Produced from the crude distillation unit 208 can be an overhead vapor stream 201, a naphtha stream 205, distillates 210, atmospheric gas oil stream 211 and an atmospheric residual cut 212. In one embodiment, a sulfidic complexing agent is dissolved in water and injected as stream 200 into the overhead condenser(s) 202 of the crude distillation unit 208. The overhead condenser 202 also receives the vapor stream 201 from the distillation column 208. Leaving the condenser 202 are a fuel gas stream 203, a sour water stream 206 and a reflux stream 204 which is returned to the column 208. From the reflux stream 204, a naphtha stream 205 can be separated. The sulfidic complexing agents capture the mercury and remove it in the overhead condensate, i.e., the naphtha stream 205. The mercury complex in this condensate can be removed as described above.

Optionally, the sulfidic complexing agent-containing stream 200 can further include an acid neutralizer e.g. ammonia to control corrosion. In another embodiment, the sulfidic complexing agent is formed from a molybdate anion. This anion can dissolve in the aqueous ammonia and react with the hydrogen sulfide that is present in the upper section of the crude unit 208 thus forming an aqueous metal sulfide colloid complexing agent. In another embodiment, the sulfidic complexing agent is mixed with a liquid hydrocarbon that contains elemental mercury, and the sulfidic complexing agent extracts the elemental mercury into a liquid or solid phase. In another embodiment, the extraction is done with liquid naphtha 205 obtained from distilling a mercury-containing crude oil 209.

### EXAMPLES

The following illustrative examples are intended to be non-limiting.

### Experimental Procedure

Into a three-neck flask with a polytetrafluoroethylene (“Teflon”) stirrer (as a glass reactor) was placed a 200 ml of solution of stannous chloride and sulfuric acid, for a concentration of 10% stannic chloride and 5% sulfuric acid. Mercury vapors were generated by injecting 0.5 cc of a 209.8 ppm Hg solution of mercuric chloride in water into the reactor via a septum. The stannic chloride rapidly reduced the mercury to elemental mercury. The glass reactor was provided with a line carrying 300 cc/min of nitrogen or CO₂, which bubbled in the reducing acidic stannous chloride solution, sweeping the evolved elemental mercury to the downstream absorbers.

The glass reactor was connected to two absorbers in series, each of which contained 200 ml of absorbing solution. The absorbers were equipped with a glass frit to produce small bubbles. The bubbles contacted the absorbing solution for about one second. The first absorber contained a test solutions that was either a sulfidic complexing agent as an example of the invention (as specified), or a control solution (as specified). The formulation of the solution in the first absorber simulated the composition of a rich MEG returning from a CO₂— rich gas field to a gas processing plant. In some experiments (as specified), methyldiethanol amine (MDEA) was added to control the pH to about 6.5 which otherwise would drop to low pH values due to the CO₂ and the acetic acid (HAc). With 100% CO₂ as a carrier gas, this solution had a pH of about 8. This is higher than the 6.5 control value because these experiments are done at atmospheric pressure rather than high pressures found in the pipeline. In some experiments the MDEA was omitted to achieve lower pH values. In other experiments the amount of HAc was varied to achieve even lower pH values.

The second absorber contained 3% sodium polysulfide in water when nitrogen was used as a carrier gas. When CO₂ was used as a carrier gas (as specified), the polysulfide precipitated, so an alternate solution of 1% iodine in Superla™ white oil was used. The 3% sodium polysulfide solution was prepared by dilution of a 30% solution of sodium polysulfide. This second absorber was a scrubber to remove the last traces of mercury from the nitrogen to provide mercury mass closures. Analysis of the exit gas from the second absorber by both a Lumex mercury analyzer (“Lumex”) available from the Ohio Lumex Company, and Jerome mercury analyzer available from Arizona instrument LLC, found no detectable mercury for all experiments.

Samples of the liquids in the reactor and two absorbers and gas leaving the reactor and leaving the two absorbers were drawn at periodic intervals over a sixty-minute period and analyzed for mercury by Lumex. The reaction of the mercury chloride in the three neck flask was rapid, and the elemental mercury was stripped rapidly as well. After a typical sixty-minute period the conversion and displacement of mercury in the reactor averaged 94% mercury converted for all experiments.

The efficiency of the test solutions was calculated by comparing the amount of mercury taken up in the first reactor absorber to the amount taken up in both absorbers. If no mercury was taken up in the first reactor with the test solution, the efficiency was zero percent. If all the mercury was taken up in the first reactor, the efficiency was 100%. At the end of the experiments no evidence of precipitated HgS was observed in the absorbers, and the solutions were clear.

### Comparative Examples 1 and 2 (Control, not of the Invention)

A 56% MEG test solution was prepared by mixing 56 wt. % monoethylene glycol (MEG) in deionized (DI) water. The carrier gas was nitrogen. The solution and deionized water itself were evaluated for mercury capture. The results as presented in Table 1 show that an insignificant amount of mercury were absorbed and retained in the test solutions in the absence of a sulfidic complexing agent.

TABLE 1

| | | Efficiency |
|---|---|---|
| Example | Solvent | % |
| Comparative | DI Water | 0 |
| 1 | | |
| Comparative | 56% MEG | 0 |
| 2 | | |

### Example 3 and Comparative Examples 4-6

The following test solution was prepared for the first absorber:
90 ml DI water
109.5 ml MEG
0.4 g Na₂S*9H₂O
HAc, amount varied to achieve pH

Sodium sulfide nonahydrate was evaluated as a pH-controlled monosulfide complexing agent at different pH values. The different pH values were obtained by varying the carrier gas and by the amount of acetic acid. Results are shown in Table 2.

TABLE 2
Impact of pH on pH-controlled monosulfide complexing agent

| | | | | S/Hg | | |
|---|---|---|---|---|---|---|
| Example | Carrier | | | Molar | | Efficiency, |
| No. | Gas | HAc, μl | S, ppm | Ratio | pH | % |
| 3 | CO₂ | 55 | 281 | 1,767 | 8 | 84.16 |
| Comparative 4 | N₂ | 55 | 264 | 1,662 | 11 | 34.49 |
| Comparative 5 | CO₂ | 165 | 266 | 1,674 | 6 | 30.83 |
| Comparative 6 | CO₂ | 275 | 253 | 1,594 | 4 | 35.28 |

Example 3 illustrates the invention. Comparative Examples 4-6 are at pH values outside of the range of the invention when pH-controlled monosulfide complexing agents are used. Without wishing to be bound by theory, at pH values greater than 9 the sulfide is believed to be in a form which is inactive for capture of elemental mercury. This might be SH— or S═. At pH values less than 7 the sulfide forms hydrogen sulfide which is stripped from the liquid by the carrier gas when operated at atmospheric pressure.

### Examples 7-10

The following test solution was prepared for the first adsorber.

| | |
|---|---|
| 90 ml DI water | 44% |
| 109.5 ml MEG | 56% |
| 55 μl HAc | 275 ppm |

CO₂ was used as the carrier gas. One tenth of a gram of various metal compounds obtained from Sigma Aldrich were dissolved in the solution and sodium sulfide was then added. Results are shown below in Table 3.

TABLE 3
Aqueous metal sulfide colloid complexing agents

| | | | S/M | | S/Hg | | |
|---|---|---|---|---|---|---|---|
| Example | | Grams | Molar | S, | Molar | | |
| No. | Metal (M) | Na₂S*9H₂O | Ratio | ppm | Ratio | pH | Efficiency, % |
| 7 | CuCl₂ | 0.3664 | 2 | 229 | 361 | 6 | 98.42 |
| 8 | SeCl₄ | 0.4401 | 3 | 275 | 867 | 6 | 87.77 |
| 9 | Na₂MoO₄*2H₂O | 0.6172 | 6 | 386 | 2,431 | 6 | 98.59 |
| 10 | FeCl₃*6H₂O | 0.18 | 2 | 113 | 709 | 6 | 92.59 |

This demonstrates that these aqueous metal sulfide colloid complexing agents are very capable of capturing elemental mercury when operated under acidic conditions. Without wishing to be bound by theory, it is believed that the sulfide is kept in solution by coordination with the metal, and this is active for capture of mercury.

### Examples 11 and 12

The solution from Example 9 was a clear amber liquid with no precipitate. Examples 8 and 10 contained finely divided solids which were recovered by filtration. These recovered solids were dried an analyzed for mercury. Results are shown in Table 4

TABLE 4
Analysis of recovered solids

| Example | | Hg in |
|---|---|---|
| No. | Metal (M) | Solids, ppb |
| 11 | SeCl₄ | 157,365 |
| 12 | FeCl₃*6H₂O | 513,527 |

This data demonstrates that the mercury in the hydrocarbon fluid can be concentrated in a small amount of waste (Hg-containing aqueous metal sulfide colloid complexing agents).

### Examples 13-19

The solution from Example 9 did not form a precipitate, but remained clear. Adsorbents were screened to identify those which were selective in removal of the mercury. In this work 10 ml of the solution from Example 9 was placed in a 40 ml vial along with approximately 0.1 grams of an adsorbent. The vial was placed on a rotating wheel and spun overnight at about 60 RPM and at room temperature. This speed gave good mixing in the vial. The following morning the samples were taken off the wheel and let to stand for 1 hour. The mercury content of the supernatant was measured. Results are summarized below in Table 5.

TABLE 5
Removal of mercury from Na₂MoO₄—Na₂S—Hg
complexes in rich MEG

| | | | % Hg |
|---|---|---|---|
| Example | Class of Adsorbent | Adsorbent | Removed |
| 13 | Anion Exchange Resin | Siemens A-244OH Resin | 7.97 |
| 14 | Anion Exchange Resin | Siemens A-464OH Resin | 5.49 |
| 15 | Anion Exchange Resin | Siemens A-674OH Resin | 10.50 |
| 16 | Anion Exchange Resin | Siemens A-714OH Resin | 46.58 |
| 17 | Anion Exchange Resin | Siemens A-284C Resin | 5.22 |
| 18 | Functional Resin | Thiosulfate polymer | 12.26 |
| 19 | Functional Resin | Thiourea Polymer | 10.72 |

### Examples 20-34

In order to screen more adsorbents, Example 9 was repeated and a solution containing the Na₂MoO₄—Na₂S—Hg complexes with 522 ppb Hg was generated. This was evaluated in the same procedure used in examples 13 to 19 with results shown in Table 6.

TABLE 6
Removal of mercury from Na₂MoO₄—Na₂S—Hg complexes in rich MEG

| Example | Class of Adsorbent | Adsorbent | % Hg Removed |
|---|---|---|---|
| 20 | Cation Exchange Resin | Dow Amberlyst 15 | 40.54 |
| 21 | Cation Exchange Resin | Dow Amberlyst 36 | 32.08 |
| 22 | Cation Exchange Resin | Dow Amberlyst 70 | 31.02 |
| 23 | Silica Alumina | Sasol Siral 1 | 97.50 |
| 24 | Diatomaceous Earth | Sigma-Aldrich Celite 545 | 36.25 |
| 25 | Alumina | PSB Industries Selexsorb CDX 7X-14 | 96.73 |
| 26 | Functional Resin | Polycrosslinked | 40.92 |
| 27 | Clay | Engelhard Filtrol F-24 | 38.43 |
| 28 | Clay | BASF F-20X | 86.69 |
| 29 | Functional Resin | Bio-Rad AG501-XB | 59.12 |
| 30 | Functional Resin | Sigma-Aldrich Dowex M-31 | 35.12 |
| 31 | Carbon | Darco Carbon Ald 242276 | 93.39 |
| 32 | Carbon | Act. Carbon Ald C2889 | 97.47 |
| 33 | Carbon | Meso. Carbon Ald 702110 | 34.86 |
| 34 | Alumina | Alumina 540 | 92.49 |
| 35 | Cu-Al₂O₃ | Clariant Actisorb 300 | 93.80 |
| 36 | Cu-Al₂O₃ | Clariant Actisorb 410 | 42.20 |
| 37 | Cu-Mo-Al₂O₃ | Clariant Actisorb G1 | 76.84 |
| 38 | Ni-Al₂O₃ | Clariant Actisorb S7 | 11.71 |
| 39 | Cu-Carbon | Calgon Carbon Sulfusorb 8 | 44.90 |
| 40 | Cu-Carbon | Calgon Carbon Sulfusorb 12 | 97.87 |
| 41 | Carbon | WV-B 1500 | 17.55 |
| 42 | Carbon | Activated Carbon Norit RO | 38.29 |
| 43 | Carbon | Activated Carbon Norit CNR 5001-0 | 59.70 |
| 44 | Silica Alumina | Sasol Siral 5 | 87.06 |
| 45 | Silica Alumina | Sasol Siral 40 | 89.01 |
| 46 | Alumina | γ-Alumina | 77.04 |
| 47 | Alumina | Activated Alumina | 79.23 |
| 48 | Titania | TiO₂ | 57.16 |
| 49 | Resin | Nafion NR50 | 8.43 |
| 50 | Zeolite | Zeolite H-Mordenite | 58.06 |
| 51 | Zeolite | Zeolite Y | 15.01 |
| 52 | Zeolite | Zeolite 4A | 19.28 |
| 53 | Zeolite | Zeolite 13X | 9.56 |
| 54 | Zeolite | Zeolite ZSM-5 | 60.73 |
| 55 | Zeolite | Zeolite 5A | 85.65 |
| 56 | Zeolite | ICR404L | 81.35 |
| 57 | Silica | Silia Flash P60 | 4.82 |
| 58 | Silica | Silica Gel Wide Pore | 9.36 |
| 59 | Silica | Silica Gel Grade 636 | 1.45 |
| 60 | Silica | Silica Gel 60 | 9.67 |

The best performing adsorbents were alumina, clays and carbons. Zeolite materials varied considerably in performance depending on both composition and framework structure. Amorphous silicas were the worst performing materials. Of the best performing adsorbents, materials containing copper metal sites for adsorption showed the highest removal rates. These include Sulfusorb 12 and Actisorb 300.

### Examples 61-68

In order to determine whether Hg-containing aqueous metal sulfide colloid complexing agents would be effective in removing elemental mercury from liquid hydrocarbons, elemental mercury was dispersed into Superla™ white oil following Example 1 of U.S. Patent Publication No. 2013/0168293. Elemental mercury dispersed in this liquid hydrocarbon would simulate elemental mercury present in liquid naphtha generated from distilling mercury-containing crudes.

Four solutions of Hg-containing aqueous metal sulfide colloid complexing agents were prepared:

0.1 g of copper (II) chloride plus 0.36 grams of sodium sulfide nonahydrate.

0.1 g of selenium (IV) chloride and 0.44 grams of sodium sulfide nonahydrate

0.1 g of sodium molybdate nonahydrate and 0.6 grams of sodium sulfide nonahydrate

0.1 g of iron (III) chloride and 0.18 grams of sodium sulfide nonahydrate

These were mixed at either 1:1 or 4:1 volume ratio with the Hg-spiked Superla™. Results are shown in Table 7. The percent mercury lost to solids was calculated as the difference between the percent mercury found in the hydrocarbon phase and the percent mercury found in the aqueous phase.

TABLE 7

| | | | | | | | | % Hg |
|---|---|---|---|---|---|---|---|---|
| | | | | | | | | Lost |
| Ex. | Metal | | Vol | Hydrocarbon | Aqueous | % Hg in | % Hg in | to |
| No. | Salt | pH | Ratio | Hg, ppb | Hg, ppb | Hydrocarbon | Aqueous | Solids |
| 61 | CuCl₂ | 11.55 | 1 | 7 | 234 | 2 | 83 | 15 |
| 62 | SeCl₄ | 11.64 | 1 | 17 | 150 | 5 | 53 | 42 |
| 63 | Na₂MoO₄ | 12.47 | 1 | 2 | 263 | 0 | 94 | 6 |
| 64 | FeCl₃ | 8.46 | 1 | 158 | 14 | 45 | 5 | 50 |
| 65 | CuCl₂ | 11.55 | 4 | 27 | 324 | 8 | 29 | 64 |
| 66 | SeCl₄ | 11.64 | 4 | 26 | 124 | 7 | 11 | 82 |
| 67 | Na₂MoO₄ | 12.47 | 4 | −6 | 1240 | −2 | 110 | −8 |
| 68 | FeCl₃ | 8.46 | 4 | 41 | 226 | 12 | 20 | 68 |

The iron (III) chloride formed an emulsion with the oil that did not break after several hours of settling. Solids were seen on the bottom of the copper, selenium and iron solutions. The molybdate solution and supernatant hydrocarbon layer remained clear with no solids.

As used herein, the term “include” and its grammatical variants are intended to be non-limiting, such that recitation of items in a list is not to the exclusion of other like items that can be substituted or added to the listed items. The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this invention belongs.

This written description uses examples to disclose the invention, including the best mode, and also to enable any person skilled in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

For the purposes of this specification and appended claims, unless otherwise indicated, all numbers expressing quantities, percentages or proportions, and other numerical values used in the specification and claims are to be understood as being modified in all instances by the term “about.” Accordingly, unless indicated to the contrary, the numerical parameters set forth in the following specification and attached claims are approximations that can vary depending upon the desired properties sought to be obtained by the present invention. It is noted that, as used in this specification and the appended claims, the singular forms “a,” “an,” and “the,” include plural references unless expressly and unequivocally limited to one referent.

What is claimed is:

1. An aqueous metal sulfide colloid complexing agent comprising a suspension or a solution formed by a reaction between a water-soluble metal compound and a water-soluble sulfidic compound;
wherein the water-soluble metal compound comprises a metal selected from the group consisting of Ti, Zr, Hg, V, Nb, Ta, Cr, Mo, W, Mn, Re, Fe, Ru, Os, Co, Rh, Ir, Ni, Pd, Pt, Cu, Ag, Au, Zn, Cd, Ga, In, Tl, Sn, Pb, As, Sb, Bi, Se, Te and combinations thereof;
wherein the water-soluble sulfidic compound is selected from the group consisting of sodium polysulfide, ammonium polysulfide, calcium polysulfide, sodium hydrosulfide, potassium hydrosulfide, ammonium hydrosulfide, sodium sulfide, potassium sulfide, calcium sulfide, magnesium sulfide, ammonium sulfide, sulfanes, hydrogen sulfide, sodium thiocarbamate, sodium dithiocarbamate, ammonium thiocarbamate and ammonium dithiocarbamate and mixtures thereof; and
wherein the aqueous metal sulfide colloid complexing agent has a pH of from about 5 to about 11 and a molar ratio of metal to sulfur of from about 0.1 to about 1,000.

2. The aqueous metal sulfide colloid complexing agent according to claim 1 wherein the water-soluble metal compound comprises a metal selected from the group consisting of Mo, W, Mn, Fe, Ni, Cu, Se and combinations thereof.

3. The aqueous metal sulfide colloid complexing agent according to claim 1 wherein the water-soluble metal compound comprises Mo.

4. The aqueous metal sulfide colloid complexing agent according to claim 1 wherein the metal in the water-soluble metal compound is in the form of an anion.

5. The aqueous metal sulfide colloid complexing agent according to claim 1 wherein the water-soluble sulfidic compound is selected from the group consisting of sodium hydrosulfide, ammonium hydrosulfide, sodium sulfide, ammonium sulfide, and combinations thereof.

6. The aqueous metal sulfide colloid complexing agent according to claim 1 wherein the molar ratio of metal to sulfur is from about 0.25 to about 1,000.

7. The aqueous metal sulfide colloid complexing agent according to claim 1 wherein the molar ratio of metal to sulfur is from about 0.5 to about 10.

8. The aqueous metal sulfide colloid complexing agent according to claim 1, further comprising mercury; wherein the molar ratio of sulfur to mercury in the aqueous metal sulfide colloid complexing agent is at least about 1.

9. The aqueous metal sulfide colloid complexing agent according to claim 8 wherein the molar ratio of sulfur to mercury is from about 2 to about 100,000.

10. The aqueous metal sulfide colloid complexing agent according to claim 9 wherein the molar ratio of sulfur to mercury is from about 10 to about 25,000.

11. The aqueous metal sulfide colloid complexing agent according to claim 1 further comprising an additive selected from the group consisting of a demulsifier, an anti-foam material, an oxygen scavenger, a scale inhibitor, a hydrate inhibitor and combinations thereof.

12. The aqueous metal sulfide colloid complexing agent according to claim 11 wherein the demulsifier is selected from polyamines, polyamidoamines, polyimines, condensates of o-toluidine and formaldehyde, quaternary ammonium compounds, ionic surfactants, polyoxyethylene alkyl phenols, and mixtures thereof.

13. The aqueous metal sulfide colloid complexing agent according to claim 11 wherein the hydrate inhibitor is a thermal inhibitor in an amount of from about 5 to about 80 vol %.

14. The aqueous metal sulfide colloid complexing agent according to claim 13 wherein the hydrate inhibitor is a low dose hydrate inhibitor in an amount from about 0.5 to about 5.0 vol %.

15. The aqueous metal sulfide colloid complexing agent according to claim 1 wherein the pH is from about 6 to about 8.

16. The aqueous metal sulfide colloid complexing agent according to claim 1 further comprising an acid neutralizer in an amount from about 0.01 to about 10 wt %.

17. The aqueous metal sulfide colloid complexing agent according to claim 16 wherein the acid neutralizer comprises methyldiethanol amine.

18. The aqueous metal sulfide colloid complexing agent according to claim 16, further comprising an acid selected from the group consisting of carbonic, acetic and combinations thereof in an amount from about 10 ppm to about 1 wt %.

19. A method for removing elemental mercury from a hydrocarbon fluid comprising:
contacting the hydrocarbon fluid with the aqueous metal sulfide colloid complexing agent of claim 1 in an aqueous phase;
wherein the molar ratio of sulfur in the aqueous metal sulfide colloid complexing agent to mercury in the hydrocarbon fluid is from about 50 to about 2,500; and
wherein at least about 90% of the mercury in the hydrocarbon fluid is removed from the hydrocarbon liquid and into the aqueous phase.

20. The method of claim 19 wherein the metal in the water-soluble metal compound is in the form of an anion.

21. The method of claim 19 wherein the contacting is conducted in the overhead of a crude unit.

22. The method of claim 19, further comprising removing the elemental mercury from the aqueous phase by a process selected from the group consisting of ion exchange, distillation, precipitation, settling, filtration, centrifugation and combinations thereof.

23. The method of claim 19, further comprising removing the elemental mercury from the aqueous phase by ion exchange.

24. A method for concurrently transporting and removing a trace amount of volatile mercury in a CO₂-containing natural gas stream extracted from a subterranean formation, comprising:
obtaining a produced fluid containing natural gas and produced water from the subterranean formation and having an initial concentration of volatile mercury;
transporting the produced fluid in a pipeline; and
injecting a sulfidic complexing agent in an aqueous phase into the pipeline carrying the produced fluid to form a treated produced fluid;
wherein volatile mercury in the produced fluid transported in the pipeline reacts with the sulfidic complexing agent to form at least one non-volatile mercury-containing complex; and
wherein the treated produced fluid has a final concentration of volatile mercury lower than the initial concentration of volatile mercury.

25. The method of claim 24, further comprising:
separating the treated produced fluid to generate a CO₂-containing natural gas stream having a reduced concentration of volatile mercury, and an aqueous mixture of produced water, non-volatile mercury-containing complex and unreacted sulfidic complexing agent; and
separating the unreacted sulfidic complexing agent and the non-volatile mercury-containing complex from the aqueous mixture, by a process selected from the group consisting of ion exchange, distillation, precipitation, settling, filtration, centrifugation and combinations thereof to generate a recovered sulfidic complexing agent with non-volatile mercury complexes, and treated produced water.

26. The method of claim 25, further comprising:
using the treated produced water as the aqueous phase in the injecting step of claim 24.

27. The method of claim 24, wherein the pipeline extends from a well head above the subterranean formation to a hydrocarbon production facility.

28. The method of claim 24, wherein the pipeline is at least about 2.5 km.

29. The method of claim 24, further comprising injecting at least one of the group consisting of an anti-foam material, an oxygen scavenger, a scale inhibitor, an acid neutralizer and a demulsifier into the produced fluid transported in the pipeline.

30. The method of claim 29, wherein the demulsifier is selected from the group consisting of polyamines, polyamidoamines, polyimines, condensates of o-toluidine and formaldehyde, quaternary ammonium compounds, ionic surfactants, polyoxyethylene alkyl phenols, and mixtures thereof.

31. The method of claim 24, wherein the produced fluid transported in the pipeline has a superficial liquid velocity of at least about 0.1 m/s.

32. The method of claim 24, wherein the final concentration of volatile mercury is at least about 50 mol % lower than the initial concentration of volatile mercury.

33. The method of claim 24, wherein the final concentration of volatile mercury is at least about 90 mol % lower than the initial concentration of volatile mercury.

34. The method of claim 24, wherein the treated produced fluid comprises natural gas containing less than about 100 μg/Nm³ mercury.

35. The method of claim 24, wherein the treated produced fluid comprises natural gas containing less than about 10 μg/Nm³ mercury.

36. The method of claim 24, wherein the treated produced fluid comprises natural gas containing less than about 1 μg/Nm³ mercury.

37. The method of claim 24, wherein the treated produced fluid comprises natural gas containing less than about 0.1 μg/Nm³ mercury.

38. The method of claim 24, wherein the sulfidic complexing agent is injected into the pipeline at a molar ratio of sulfidic complexing agent to volatile mercury ranging from 1:1 to 100,000:1.

39. The method of claim 24, wherein the sulfidic complexing agent is injected into the pipeline at a molar ratio of sulfidic complexing agent to volatile mercury ranging from 2:1 to 25,000:1.

40. The method of claim 24, wherein the sulfidic complexing agent is injected into the pipeline in an amount up to about 5 wt. % of the produced water in the pipeline.

41. The method of claim 24, wherein the sulfidic complexing agent is injected into the pipeline in an amount up to about 2 wt. % of the produced water in the pipeline.

42. The method of claim 24, wherein the sulfidic complexing agent is a pH controlled monosulfide complexing agent.

43. The method of claim 42, wherein the monosulfide complexing agent is selected from the group consisting of sodium hydrosulfide, ammonium hydrosulfide, sodium sulfide, ammonium sulfide, and combinations thereof.

44. The method of claim 24, further comprising injecting an effective amount of a hydrate inhibitor into the produced fluid being transported in the pipeline; and wherein the treated produced fluid has a concentration of hydrate particles of less than about 50 vol %.

45. The method of claim 44, wherein the hydrate inhibitor is a thermal inhibitor and the effective amount of the thermal inhibitor ranges from about 5 to about 80 vol % of the produced water in the pipeline.

46. The method of claim 44, wherein the hydrate inhibitor is a low dose hydrate inhibitor and the effective amount of the low dose hydrate inhibitor ranges from about 0.5 to about 5.0 vol % of the produced water in the pipeline.

47. The method of claim 24, wherein the sulfidic complexing agent is an aqueous metal sulfide colloid complexing agent according to claim 1.

48. A method for capturing gas phase elemental mercury from a hydrocarbon fluid in an overhead section of a crude oil distillation unit, comprising:
contacting a hydrocarbon fluid having an initial concentration of gas phase elemental mercury with a sulfidic complexing agent in an overhead section of a crude oil distillation unit to form a treated hydrocarbon fluid;
wherein the gas phase elemental mercury reacts with the sulfidic complexing agent to form at least one non-volatile mercury-containing complex; and
wherein the treated hydrocarbon fluid has a final concentration of gas phase elemental mercury lower than the initial concentration of gas phase elemental mercury.

49. The method of claim 48 wherein the sulfidic complexing agent is injected into an overhead condenser of the crude oil distillation unit simultaneously with an overhead vapor stream from the crude oil distillation unit.

50. The method of claim 49 wherein the sulfidic complexing agent is contained in an aqueous phase further comprising an acid neutralizer for use as a corrosion inhibitor.

51. The method of claim 48 wherein the sulfidic complexing agent is formed during operation of the crude oil distillation unit by a reaction of molybdate anion present in a corrosion inhibitor comprising aqueous ammonia with hydrogen sulfide present in an upper section of the crude oil distillation unit.
